(19) United States
(12) Patent Application Publication
(10) Pub. No.: US 2019/0329744 A1
(43) Pub. Date: Oct. 31, 2019

(54) ALERT AND CONTROL SYSTEM AND METHOD FOR ASSISTING DRIVER

(71) Applicant: MANDO CORPORATION, Pyeongtaek-si (KR)

(72) Inventor: Jae Suk Kim, Yongin-si (KR)

(21) Appl. No.: 16/371,644

(22) Filed: Apr. 1, 2019

(30) Foreign Application Priority Data
Apr. 25, 2018 (KR) 10-2018-0047869

(51) Int. Cl. B60T 7/22; B60Q 9/00; B60T 8/17; B60T 8/171; B60T 8/58

(52) U.S. Cl. CPC B60T 7/22; B60Q 9/008; B60T 8/17; B60T 2250/04; B60T 8/58; B60T 2240/00; B60T 8/171

(57) ABSTRACT

Disclosed are an alert and control system for assisting a driver and a method thereof, which may accurately determine an actual driving state of a vehicle by determining the driving state of the vehicle based on a gear signal of the vehicle, previous driving state information, movement state information, a first wheel direction signal, and a second wheel direction signal. Further, it is possible to improve control performance to avoid a collision which may be generated in a direction that matches a driving direction of the vehicle by performing a collision prevention control of the vehicle based on the actual driving state and to prevent an unpredicted risk due to an unnecessary alert or control.

### CROSS REFERENCE TO RELATED APPLICATION

This application claims priority from Korean Patent Application No. 10-2018-0047869, filed on Apr. 25, 2018, which is hereby incorporated by reference for all purposes as if fully set forth herein.

### BACKGROUND OF THE INVENTION

### 1. Field of the invention

The present disclosure relates to a system and a method for alerting and controlling driver assistance to prevent a collision between vehicles.

### 2. Description of the Prior Art

According to an increase in demand for driver safety and convenience in a high-performing vehicle, a Driver Assist System (DAS) for supporting the driver control while driving or parking or performing a control to prevent a collision of the vehicle is provided.

The DAS improves the safety of a vehicle and provides convenience to the driver who controls the vehicle by controlling steering and braking of the vehicle on the basis of information acquired through sensors mounted to the vehicle or information transmitted/received through a communication module.

For example, the DAS may include Smart Cruise Control (SCC) for providing driving convenience to the driver, a Smart Parking Assist System (SPAS) for providing driving convenience to the driver, an Autonomous Emergency Braking (AEB) system for preventing a collision of the vehicle, a Rear Cross Traffic Alert (RCTA) system, and a Blind Spot Detection (BSD) system.

Particularly, the AEB system or the RCTA system may predict a collision between the vehicle and an object detected through a sensor mounted to the vehicle and control the vehicle to prevent the collision between the vehicle and the object, thereby improving safety of the vehicle.

Accordingly, development of a technology for increasing accuracy of the control of the vehicle in order to prevent a malfunction of the DAS is required.

### SUMMARY OF THE INVENTION

An aspect of the present embodiments is to provide a system and a method for alerting and controlling driver assistance, which control a vehicle to prevent a collision between the moving vehicle and an object located around the vehicle.

Another aspect of the present embodiments is to provide a system and a method for alerting and controlling driver assistance which minimize driver inconvenience and improve safety of the vehicle by improving accuracy of the operation of the DAS for preventing a collision of the vehicle.

In accordance with an aspect of the present disclosure, an alert and control system for assisting a driver is provided. The alert and control system includes: an intra-vehicle sensor module configured to sense intra-vehicle information, and a controller communicatively connected to the intra-vehicle sensor module and configured to: receives at least one of a vehicle speed signal or a wheel pulse signal sensed by the intra-vehicle sensor module, outputs movement state information, based on at least one of the vehicle speed signal or the wheel pulse signal, receives a gear signal, a first wheel direction signal, and a second wheel direction signal sensed by the intra-vehicle sensor module, outputs second driving state information, based on first driving state information when the gear signal is received, the gear signal, the first wheel direction signal, the second wheel direction signal, and the movement state information, and controls an operation of at least one of an alert device or a brake device, based on the second driving state information.

In accordance with another aspect of the present disclosure, an alert and control method of assisting a driver is provided. The alert and control method includes: receiving at least one of a vehicle speed signal or a wheel pulse signal sensed by an intra-vehicle sensor module, outputting movement state information, based on at least one of a vehicle speed signal or a wheel pulse signal, receiving a gear signal, a first wheel direction signal, and a second wheel direction signal sensed by the intra-vehicle sensor module, outputting second driving state information, based on first driving state information when the gear signal is received, the gear signal, the first wheel direction signal, the second wheel direction signal, and the movement state information, and controlling an operation of at least one of an alert device or a brake device, based on the second driving state information.mounted tomounted to

According to the present embodiments, it is possible to acquire accurate driving state information of a vehicle by outputting driving state information of the vehicle based on not only a gear signal of the vehicle but also wheel direction signals and movement state information.

According to the present embodiments, it is possible to minimize generation of unnecessary alerts and perform accurate collision prevention control by performing control to prevent a collision with an object located ahead or behind the vehicle based on accurate driving state information of the vehicle, thereby improving driver convenience and safety of the vehicle.

### BRIEF DESCRIPTION OF THE DRAWINGS

The above and other aspects, features and advantages of the present disclosure will be more apparent from the following detailed description taken in conjunction with the accompanying drawings, in which:

FIG. 1 illustrates an example of a situation in which an alert and control system for assisting a driver operates according to the present embodiments;

FIG. 2A illustrates a first embodiment of the alert and control system for assisting a driver according to the present embodiments;

FIG. 2B illustrates a second embodiment of the alert and control system for assisting a driver according to the present embodiments;

FIG. 3 illustrates a first embodiment of a process in which the alert and control system for assisting a driver determines a driving state of the vehicle according to the present embodiments;

FIGS. 4 to 7 illustrate a second embodiment of the process in which the alert and control system for assisting a driver determines a driving state of the vehicle according to the present embodiments;

FIG. 8 illustrates an example of a process in which the alert and control system for assisting a driver performs a vehicle control according to the determined driving state according to the present embodiments; and

FIG. 9 illustrates an example of a method of operating a driver assist system based on the driving state determined by the alert and control system for assisting a driver according to the present embodiments.

### DETAILED DESCRIPTION OF THE EXEMPLARY EMBODIMENTS

Hereinafter, some embodiments of the present disclosure will be described in detail with reference to the accompanying illustrative drawings. In designating elements of the drawings by reference numerals, the same elements will be designated by the same reference numerals although they are shown in different drawings. Further, in the following description of the present disclosure, a detailed description of known functions and configurations incorporated herein will be omitted when it may make the subject matter of the present disclosure rather unclear.

In addition, terms, such as first, second, A, B, (a), (b) or the like may be used herein when describing components of the present disclosure. These terms are merely used to distinguish one component from other components, and the property, order, sequence and the like of the corresponding component are not limited by the corresponding term. In the case that it is described that a certain structural element “is connected to”, “is coupled to”, or “is in contact with” another structural element, it should be interpreted that another structural element may “be connected to”, “be coupled to”, or “be in contact with” the structural elements as well as that the certain structural element is directly connected to or is in direct contact with another structural element.

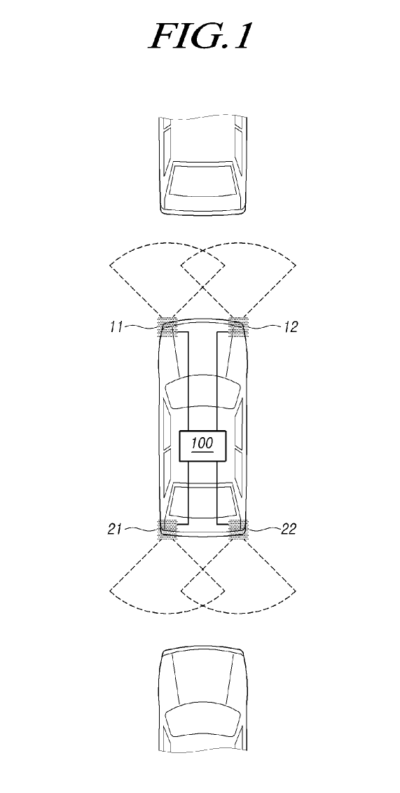

FIG. 1 illustrates an example of a situation in which an alert and control system 100 for assisting a driver (hereinafter, referred to as an alert and control system) operates according to the present embodiments.

Referring to FIG. 1, the alert and control system 100 according to the present embodiments detects an object located (stopped or moving) in a direction in which a vehicle moves and determines a possibility of a collision between the vehicle and the detected object. When it is determined that there is a possibility of collision between the vehicle and the object, the alert and control system 100 may output an alert and allow the driver to avoid the collision or control steering or braking of the vehicle and prevent the collision between the vehicle and the object.

For example, when the vehicle moves forward, the alert and control system 100 according to the present embodiments detect an object located ahead of the vehicle through first sensors 11 and 12 mounted to the front part of the vehicle. Further, the alert and control system 100 controls the vehicle according to the possibility of the collision with the object ahead.

When the vehicle moves backward, the alert and control system 100 according to the present embodiments may detect an object located behind the vehicle through second sensors 21 and 22 mounted to the rear part of the vehicle and control the vehicle according to the possibility of the collision with the object located behind the vehicle.

The alert and control system 100 may be implemented as a single system or may be separately implemented as a control system for preventing a forward collision and a control system for preventing a backward collision.

Further, the example of FIG. 1 illustrates the case in which the first sensors 11 and 12 or the second sensors 21 and 22 are mounted to points at which the side surfaces of the vehicle intersect the front part/rear part, but the locations at which the first sensors 11 and 12 and the second sensors 21 and 22 are mounted may be variously designed and various types of sensors such as radar sensors and ultrasound sensors may be used therefor.

As described above, the alert and control system 100 according to the present embodiments may detect the object through the sensors mounted to the front part or the rear part of the vehicle and perform alert or control to prevent the collision of the vehicle, so as to improve safety of the vehicle and provide convenience to the driver.

The alert and control system 100 may operate to prevent the forward collision or the backward collision according to a driving direction of the vehicle. This is because an unnecessary alert or braking may be generated and thus the driver is inconvenienced or an unpredicted accident may occur if the collision prevention logic for a direction different from the driving direction of the vehicle is performed.

Accordingly, the alert and control system 100 according to the present embodiments may determine the driving direction of the vehicle based on, for example, a gear signal of the vehicle and perform alert and control to prevent the forward or backward collision according to the driving direction of the vehicle.

However, at a time point at which the gear signal of the vehicle is changed from a drive gear to a reverse gear or from a reverse gear to a drive gear, the gear signal of the vehicle may not match the actual driving direction of the vehicle. When the gear signal does not match the driving direction, the operation based on the gear signal may cause a malfunction of the alert and control system 100.

The alert and control system 100 according to the present embodiments may determine a driving state of the vehicle in consideration of a gear signal of the vehicle, a wheel direction signal, and motion state information of the vehicle and perform alert and control, so as to improve accuracy of the alert and control for preventing the collision of the vehicle.

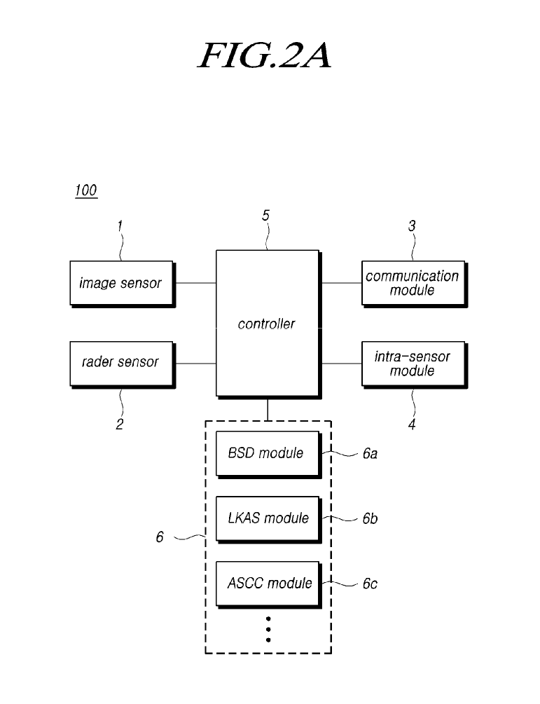

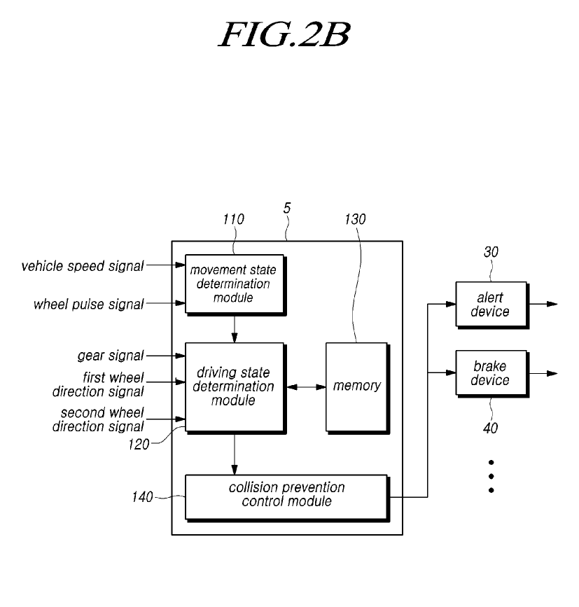

FIG. 2A illustrates a first embodiment of the alert and control system 100 for assisting a driver according to the present embodiments.

Referring to FIG. 2A, the alert and control system 100 for assisting a driver according to the present embodiments may include an image sensor 1, a radar sensor 2, a communication module 3, an intra-vehicle sensor module 4, a controller 5, and a driver assist system module 6.

For example, the image sensor 1 may have a field of view of an interior or an exterior of the vehicle 11 and capture image data and may include a processor configured to process the captured image data.

For example, the image sensor 1 may be mounted to the vehicle 11 to have a field of view of an interior or an exterior of the vehicle 11. At least one image sensor 1 may be mounted to each part of the vehicle 11 to have a field of view of the front, side, or rear of the vehicle 11.

For example, the image sensor 1 includes a camera, a LiDAR sensor.

Image information captured by the image sensor 1 consists of image data and thus may refer to image data captured by the image sensor 1. Hereinafter, image information captured by the image sensor 1 in the present disclosure means image data captured by the image sensor 1. The image data captured by the image sensor 1 may be generated, for example, in one format of AVI, MPEG-4, H.264, DivX, and JPEG in a raw form.

The image data captured by the image sensor 1 may be processed by a processor. The processor may operate to process the image data captured by the image sensor 1.

The processor may be implemented using at least one of electrical units for processing image data or performing other functions such as Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, and micro-processors in hardware.

Meanwhile, the radar sensor 2 is a sensor module other than the image sensor 1 for capturing an image. For example, a plurality of radar sensors 2 may be mounted to the vehicle 11 to have a sensing area of an interior or an exterior of the vehicle 11 to capture sensing data.

The communication module 3 performs a function of performing communication between vehicles, communication between a vehicle and infrastructure, communication between a vehicle and a server, and communication inside a vehicle. To this end, the communication module 3 may include a transmission module and a reception module. For example, the communication module 3 may include a broadcast reception module, a wireless Internet module, a short-range communication module, a location information module, an optical communication module, and a V2X communication module.

The broadcast reception module receives broadcast signals and/or broadcast-related information from external broadcast management servers through broadcasting channels. Here, the broadcast includes at least one of a radio broadcast and a TV broadcast. The wireless Internet module may be a module for wireless Internet access and may be mounted inside or outside the vehicle. The short-range communication module is for short-range communication and may support short-range communication through at least one of Bluetooth™, Radio Frequency Identification (RFID), Infrared Data Association (IrDA), Ultra Wideband (UWB), ZigBee, Near Field Communication (NFC), Wi-Fi, Wi-Fi Direct, and wireless Universal Serial Bus (USB).

The location information module is a module for acquiring location information of the vehicle 11 and representatively includes a Global Positioning System (GPS) module. For example, when a GPS module is used, the vehicle 11 may acquire the location of the vehicle 11 through a signal transmitted from a GPS satellite. Meanwhile, according to embodiments, the location information module may be an element included in the intra-vehicle sensor module 4 rather than an element included in the communication module 3.

The optical communication module may include an optical transmitter and an optical receiver. The optical transmitter and the optical receiver may convert a light signal into an electrical signal and transmit/receive information.

The V2X communication module is a module for performing wireless communication with a server, another vehicle, or an infrastructure device. The V2X communication module according to the present embodiment means an exchange of information between the vehicle and objects, such as another vehicle, a module device, and a road, through a wired/wireless network, or technology itself therefor. The V2X communication module may include concepts of Vehicle to Vehicle (V2V), Vehicle to Infrastructure (V2I), Vehicle to Nomadic Device (V2N), and Vehicle to Pedestrian (V2P). The V2X communication module is based on Dedicated Short-Range Communications (DSRC), and may use Wireless Access in Vehicular Environment (WAVE), recently developed by IEEE or IEEE 802.11p communication technology, using a 5.9 GHz band, but is not limited thereto. It should be understood that V2X includes any vehicle-to-vehicle communication that does not exist at present but is to be developed in the future.

The intra-vehicle sensor module 4 is a sensor for sensing internal information of the vehicle. For example, the intra-vehicle sensor module 4 may be a torque sensor for sensing steering torque, a steering angle sensor for sensing a steering angle, a motor location sensor for sensing information on a steering motor, a vehicle speed sensor, a vehicle motion detection sensor for sensing motion of the vehicle 11, and a vehicle position detection sensor. In addition, the intra-vehicle sensor module 4 may be a sensor for sensing various pieces of data inside the vehicle 11 and the number thereof may be one or more.

In other words, the intra-vehicle sensor module 4 may generate a vehicle speed signal, a wheel pulse signal, a gear signal, a first wheel direction signal, and a second wheel direction signal and output the generated signals to the controller 5.

The controller 5 may acquire data from at least one of the image sensor 1, the radar sensor 2, the communication module 3, and the intra-vehicle sensor module 4 and control various operations of the vehicle 11 based on the acquired data. Alternatively, the controller 5 may acquire image data from the image sensor 1 and process the image data. Further, the controller 5 may receive sensing data from the radar sensor 2 and process the sensing data. Alternatively, the controller 5 may acquire data from the intra-vehicle sensor module 4 or the communication module 3 and process the data. For the processing, the controller 5 may include at least one processor.

The alert and control system 100 for assisting a driver according to the present disclosure may be implemented through a combination of the above-described elements as necessary. For example, the alert and control system 100 includes the image sensor 1, the radar sensor 2, and the controller 5. In another example, the alert and control system 100 includes the image sensor 1 and the controller 5. In still another example, the alert and control system 100 includes the radar sensor 2 and the controller 5. However, the present disclosure is not limited thereto.

Specifically, the alert and control system 100 may include the image sensor 1 mounted to a vehicle to have a field of view of an interior or an exterior of the vehicle and configured to capture image data and process the captured image data; at least one radar sensor 2 mounted to the vehicle to have a sensing area of an interior or an exterior of the vehicle and configured to capture sensing data and process the captured sensing data; the intra-vehicle sensor module configured to sense intra-vehicle information; and the controller 5 configured to control the vehicle according to driving state information, based on processing of at least one piece of the image data and the sensing data and the intra-vehicle information

The controller 5 may receive at least one of a vehicle speed signal or a wheel pulse signal sensed by the intra-vehicle sensor module 4, and output movement state information, based on at least one of the vehicle speed signal or the wheel pulse signal, and receive a gear signal, a first wheel direction signal, and a second wheel direction signal sensed by the intra-vehicle sensor module 4, and output second driving state information, based on first driving state information when the gear signal is received, the gear signal, the first wheel direction signal, the second wheel direction signal, and the movement state information, and control an operation of at least one of an alert device or a brake device, based on the second driving state information.

wherein, if both a driving direction indicated by the gear signal and a driving direction indicated by the first driving state information are a first direction, the controller 5 outputs a driving state indicating the second direction as the second driving state information if the movement state information is a moving state and both directions indicated by the first wheel direction signal and the second wheel direction signal are a second direction.

wherein, if a driving direction indicated by the gear signal is a first direction and a driving direction indicated by the first driving state information is a second direction, the controller 5 outputs a driving state indicating the first direction as the second driving state information if the movement state information is a stopped state, or the movement state information is a moving state and at least one of directions indicated by the first wheel direction signal and the second wheel direction signal is a first direction.

wherein, if the gear signal is a drive gear and the first driving state information is a forward movement state, the controller 5 outputs a reverse movement state as the second driving state information if the movement state information is a moving state and both directions indicated by the first wheel direction signal and the second wheel direction signal are a reverse movement direction.

wherein, if the gear signal is a drive gear and the first driving state information is a reverse movement state, the controller 5 outputs a forward movement state as the second driving state information if the movement state information is a stopped state, or the movement state information is a moving state and at least one of directions indicated by the first wheel direction signal and the second wheel direction signal is a forward movement direction.

wherein, if the gear signal is a drive gear and the first driving state information is a stopped state, the controller 5 outputs a reverse movement state as the second driving state information if both directions indicated by the first wheel direction signal and the second wheel direction signal are a reverse movement direction, and the controller 5 outputs a forward movement state as the second driving state information if the movement sate information is a stopped state or at least one of directions indicated by the first wheel direction signal and the second wheel direction signal is a forward movement direction.

wherein, if the gear signal is a reverse gear and the first driving state information is a reverse movement state, the controller 5 outputs a forward movement state as the second driving state information if the movement state information is a moving state and both directions indicated by the first wheel direction signal and the second wheel direction signal are a forward movement direction.

wherein, if the gear signal is a reverse gear and the first driving state information is a forward movement state, the controller 5 outputs a reverse movement state as the second driving state information if the movement state information is a stopped state, or the movement state information is a moving state and at least one of directions indicated by the first wheel direction signal and the second wheel direction signal is a reverse movement direction.

wherein, if the gear signal is a reverse gear and the first driving state information is a stopped state,

the controller 5 outputs a forward movement state as the second driving state information if both directions indicated by the first wheel direction signal and the second wheel direction signal are a forward movement direction, and the controller 5 outputs a reverse movement state as the second driving state information if the movement state information is a stopped state or at least one of directions indicated by the first wheel direction signal and the second wheel direction signal is a reverse movement direction.

wherein, if the gear signal is a gear other than a drive gear and a reverse gear and the movement sate information is a moving state, the controller 5 outputs a reverse movement state as the second driving state information if both directions indicated by the first wheel direction signal and the second wheel direction signal are a reverse movement direction, and the controller 5 outputs a forward movement state as the second driving state information if both directions indicated by the first wheel direction signal and the second wheel direction signal are a forward movement direction.

In addition, the controller 5 may control the operation of at least one of the image sensor 1, the radar sensor 2, the communication module 3, the intra-vehicle sensor module 4, and the driver assist system module 6. The controller 5 may control the operation of various driver assist systems included in the vehicle.

The ADAS module may be the implementation of a module by various driver assist system modules 6, and the driver assist system modules 6 may include, for example, an Autonomous Emergency Braking (AEB) system module for preventing a collision of the host vehicle, a Rear Cross Traffic Alert (RCTA) system module, a Smart Parking Assistance System (SPAS) module, a Blind Spot Detection (BSD) system module 7a, a Lane Departure Warning System (LDWS), a Lane Keeping Assist System (LKAS), Lane Change Assist System (LCAS) module 7b, and an Adaptive Cruise Control (ACC) system module 7c.

However, the present disclosure is not limited thereto. The terms and names of the driver assist system modules 6 described herein are only for examples and are not limited thereto. The driver assist system modules 6 may include an autonomous driving module for autonomous driving.

Meanwhile, the controller 5 can be implemented as modules capable of individually performing the above-described operations. Hereinafter, the alert and control system 100 for assisting the driver including the modules capable of performing the operations of the controller 5 will be described.

FIG. 2B illustrates a second embodiment of the alert and control system 100 for assisting the driver according to the present embodiments.

Referring to FIG. 2B, the controller 5 may include a movement state determination module 110, a driving state determination module 120, a memory 130, and a collision prevention control module 140. The elements may be implemented as a partial module of a domain control unit or an Electronic Control Unit (ECU) or two or more elements may be integrated to one module.

The movement state determination module 110 receives at least one of the vehicle speed signal or the wheel pulse signal and determines a movement state of the vehicle based on the received signal. Further, the movement state determination module 110 outputs movement state information according to the movement state of the vehicle.

For example, the movement state determination module 110 may determine whether the vehicle is in a moving state or a stopped state based on whether the vehicle speed signal received from the vehicle speed sensor is 0. Further, the movement state determination module 110 may identify whether wheels rotate based on the wheel pulse signal received from the wheel sensor and determine whether the vehicle is in the moving state or the stopped state.

The movement state determination module 110 may output movement state information according to the determination result of the movement state of the vehicle and, for example, may output “0” if the vehicle is in the moving state and output “1” if the vehicle is in the stopped state.

The driving state determination module 120 receives the movement state information from the movement state determination module 110. Further, the driving state determination module 110 receives the gear signal, the first wheel direction signal, and the second wheel direction signal.

The first wheel direction signal and the second wheel direction signal may be signals received from wheels rotating in different directions. For example, the first wheel direction signal may be a signal received from right wheels rotating in a first direction if the vehicle travels forward and the second wheel direction signal may be a signal received from left wheels rotating in a second direction opposite the first direction if the vehicle travels forward.

The driving state determination module 120 may determine the driving state of the vehicle based on the received movement state information, the gear signal, the first wheel direction signal, and the second wheel direction signal. Further, the driving state of the vehicle may be determined in consideration of first driving state information if the gear signal is received as well as the above described signals and information.

The first driving state information is information indicating the driving state if the driving state determination module 120 receives the gear signal, and corresponds to driving state information determined before the driving state determination module 120 determines the driving state based on the newly received signal and information or stored in the memory 130.

That is, the driving state determination module 120 outputs second driving state information which is information related to a new driving state of the vehicle based on the first driving state information at a time point at which the gear signal is received and the gear signal. Further, the driving state determination module 120 may accurately identify the actual driving direction of the vehicle based on the second driving state information.

For example, if the driving direction indicated by the gear signal and the driving direction indicated by the first driving state information are the same as each other, for example, the first direction, the driving state determination module 120 may output the second driving state information based on the first wheel direction signal and the second wheel direction signal.

Specifically, if both the gear signal and the first driving state information indicate that the vehicle travels in the first direction, the driving state determination module 120 outputs the driving state indicating the second direction as the second driving state information if the movement state information corresponds to the moving state and the directions indicated by the first wheel direction signal and the second wheel direction signal are all the second direction.

That is, if the movement state information corresponds to the moving state and both the driving directions indicated by the first wheel direction signal and the second wheel direction signal are the reverse direction, it is determined that the vehicle is reversed although the gear signal and the first driving state information indicate that the vehicle travels forward.

Accordingly, even if the vehicle moves in a direction opposite the driving direction indicated by the gear signal, the actual driving direction of the vehicle can be accurately determined.

In another example, if the driving direction indicated by the gear signal is different from the driving direction indicated by the first driving state information, for example, if the driving direction indicated by the gear signal is the first direction and the driving direction indicated by the first driving state information is the second direction, the driving state determination module 120 may output the second driving state information based on at least one of the movement state information, the first wheel direction signal, or the second wheel direction signal.

Specifically, if the gear signal indicates driving of the vehicle in the first direction and the first driving state information indicates driving of the vehicle in the second direction, the driving state determination module 120 may output the driving state indicating the first direction as the second driving state information if the movement state information corresponds to the stopped state. Further, if the direction indicated by at least one of the first wheel direction signal or the second wheel direction signal is the first direction, the determination module 120 may output the driving state indicating the first direction as the second driving state information.

That is, if the movement state information of the vehicle corresponds to the stopped state, the determination module 120 outputs the second driving state information of the vehicle by preferentially considering the gear signal. Further, if the driving directions indicated by the gear signal and the first driving state information are different, it is determined that the vehicle travels in a direction according to the gear signal if the direction indicated by at least one of the first wheel direction signal or the second wheel direction signal is the same as the direction indicated by the gear signal.

As described above, the driving state determination module 120 may output information on the accurate driving state of the vehicle by outputting the second driving state information of the vehicle in consideration of not only the gear signal of the vehicle but also previous driving state information of the vehicle (first driving state information), movement state information related to the actual movement of the vehicle, the first wheel direction signal, and the second wheel direction signal.

The collision prevention control module 140 receives the second driving state information from the driving state determination module 120 and performs a control to prevent the collision of the vehicle based on the received second driving state information.

For example, if the second driving state information corresponds to the forward movement state, the collision prevention control module 140 determines the collision possibility with the object ahead of the vehicle and controls an alert device 30 or a brake device 40 to alert or avoid the collision. If the second driving state information corresponds to the rear movement state, the collision prevention control module 140 determines the collision possibility with the object behind the vehicle and controls the alert device 30 or the brake device 40 to alert or avoid the collision.

Further, in order to prevent the collision of the vehicle, the collision prevention control module 140 may control a device required for avoiding the collision, such as a steering device, as well as the alert device 30 or the brake device 40.

The collision prevention control module 140 may directly perform the alert and avoid control to avoid the collision of the vehicle according to the second driving state information. Alternatively, the collision prevention control module 140 may control the operation of any driver assist system required for avoiding the collision according to the second driving state information.

That is, the collision prevention control module 140 may control the AEB system for avoiding the front collision of the vehicle to operate if the second driving state information corresponds to the forward movement state, and may perform a control to operate the RCTA system for avoiding the rear-side collision of the vehicle if the second driving state information corresponds to the reverse movement state.

The controller 5 may accurately determine the actual driving direction of the vehicle and perform the collision avoidance control based on the determined driving direction, thereby preventing an unnecessary alert and control from being generated and avoid the collision which may occur in the actual driving direction of the vehicle.

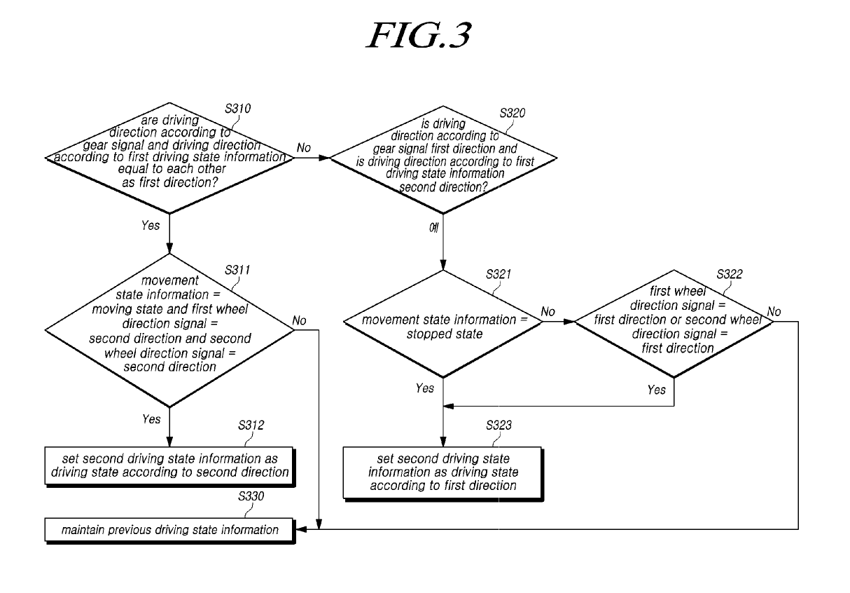

FIG. 3 illustrates a first embodiment of a process in which the alert and control system 100 determines a driving state of the vehicle according to the present embodiments.

Referring to FIG. 3, the controller 5 according to the present embodiments identifies whether the driving direction according to the gear signal and the driving direction according to the first driving state information are the same as each other, as the first direction in S310.

If both the driving direction according to the gear signal and the driving direction according to the first driving state information are the first direction, if the movement state information corresponds to the moving state and both directions indicated by the first wheel direction signal and the second wheel direction signal are the second direction in S311, the controller 5 sets the second driving state information to be the driving state according to the second direction in S312.

If the movement state information corresponds to the stopped state or at least one of the first wheel direction signal and the second wheel direction signal does not indicate the second direction, the controller 5 maintains the second driving state information to be the same as the previous driving state information, which is the first driving state information in S330.

If the driving direction according to the gear signal is the first direction and the driving direction according to the first driving state information is the second direction in S320, the controller 5 identifies the movement state information.

If the movement state information corresponds to the stopped state in S321, the controller 5 sets the second driving state information to be the driving state according to the first direction, which is the same as the direction indicated by the gear signal, in S323.

If the movement state information does not correspond to the stopped state, the controller 5 identifies the first wheel direction signal and the second wheel direction signal. If the direction indicated by at least one of the first wheel direction signal or the second wheel direction signal is the first direction in S322, the controller 5 sets the second driving state information to be the driving state according to the first direction, which is the same as the direction indicated by the gear signal, in S323.

If the movement state information, the first wheel direction signal, and the second wheel direction signal do not meet the above-described condition, the controller 5 maintains the second driving state information to the same as the first driving state information which is the previous driving state information in S330.

As described above, the controller 5 according to the present embodiments may determine the driving state of the vehicle based on the movement state information, the first wheel direction signal, and the second wheel direction signal and accurately determine the actual driving state of the vehicle even if it is not easy to determine the current driving state of the vehicle based on the gear signal of the vehicle and the driving state information or even if the gear signal and the previous driving state information are different.

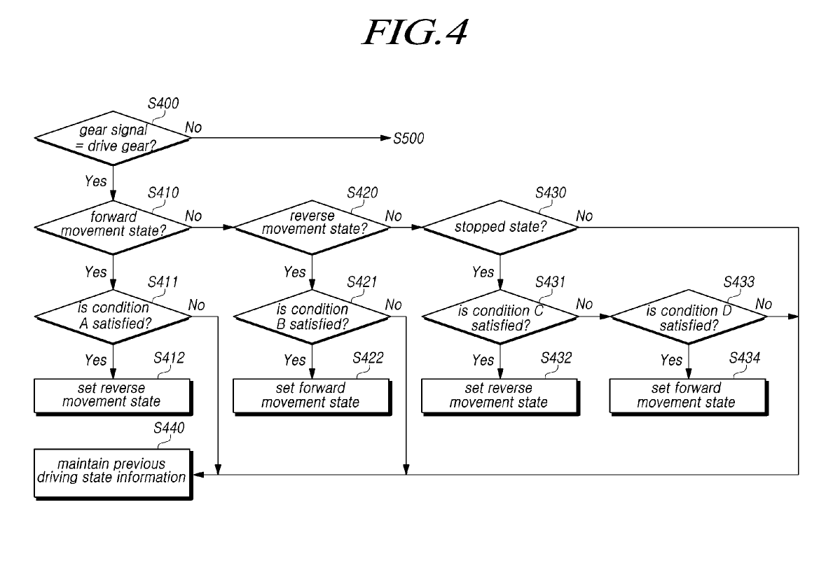

FIGS. 4 to 7 illustrate a second embodiment of a process in which the controller 5 determines the driving state of the vehicle according to the present embodiments, which is an example of a more detailed process.

Referring to FIG. 4, the controller 5 according to the present embodiments identifies first driving state information which is previous driving state information of the vehicle if the gear signal of the vehicle is a drive gear in S400.

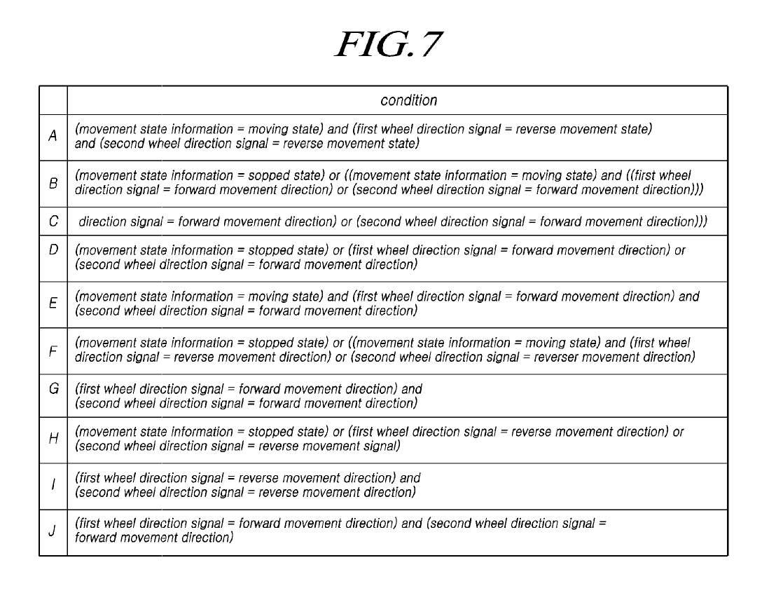

If the first driving state information corresponds to the forward movement state, in S410 the controller 5 identifies whether condition A of FIG. 7 is satisfied. Condition A corresponds to the case in which the movement state information is the moving state and both the first wheel direction signal and the second wheel direction signal indicate the reverse movement direction. If condition A is satisfied in S411, the controller 5 sets the second driving state information as the reverse movement state in S412. If condition A is not satisfied, the controller 5 maintains the second driving state information to be the forward movement state which is the previous driving state information in S440.

If the first driving state information is the reverse movement state in S420, the controller 5 identifies whether condition B of FIG. 7 is satisfied. Condition B corresponds to the case in which the movement state information is the stopped state or the moving state and at least one of the first wheel signal or the second wheel signal indicates the forward movement direction. If condition B is satisfied in S421, the controller 5 sets the second driving state information as the forward movement state in S422. If condition B is not satisfied, the controller 5 maintains the second driving state information to be the reverse movement state which is the previous driving state information in S440.

If the first driving state information is the stopped state in S430, the controller 5 identifies whether condition C of FIG. 7 is satisfied. Condition C corresponds to the case in which both the first wheel direction signal and the second wheel direction signal indicate the reverse movement direction. If condition C is satisfied in S431, the controller 5 sets the second driving state information as the reverse movement state in S432.

If condition C is not satisfied, the controller 5 identifies whether condition D of FIG. 7 is satisfied. Condition D corresponds to the case in which the movement state information is the stopped state or at least one of the first wheel direction signal or the second wheel direction signal indicates the forward movement direction. If condition D is satisfied in S433, the controller 5 sets the second driving state information as the forward movement state in S434. If condition D is not satisfied, the controller 5 maintains the second driving state information to be the stopped state which is the previous driving state information in S440.

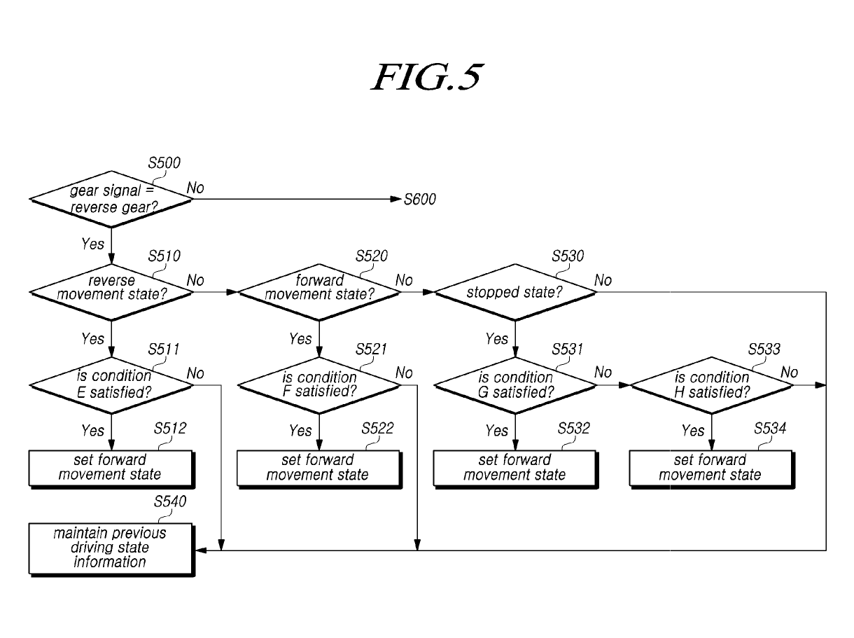

Referring to FIG. 5, if the gear signal of the vehicle is the reverse gear in S500, the controller 5 according to the present embodiments identifies the first driving state information which is the previous driving state information of the vehicle.

If the first driving state information is the reverse movement state in S510, the controller 5 identifies whether condition E of FIG. 7 is satisfied. Condition E corresponds to the case in which the movement state information is the moving state and both the first wheel direction signal and the second wheel direction signal indicate the forward movement direction. If condition E is satisfied in S511, the controller 5 sets the second driving state information as the forward movement state in S512. If condition E is not satisfied, the controller 5 maintains the second driving state information to be the reverse movement state which is the previous driving state information in S540.

If the first driving state information is the forward movement state in S520, the controller 5 identifies whether condition F of FIG. 7 is satisfied. Condition F corresponds to the case in which the movement state information is the stopped state or the movement state information is the moving state and at least one of the first wheel direction signal or the second wheel direction signal indicates the reverse movement direction. If condition F is satisfied in S521, the controller 5 sets the second driving state information as the reverse movement state in S522. If condition F is not satisfied, the controller 5 maintains the second driving state information to be the forward movement state which is the previous driving state information in S540.

If the first driving state information is the stopped state in S530, the controller 5 identifies whether condition G of FIG. 7 is satisfied. Condition G corresponds to the case in which both the first wheel direction signal and the second wheel direction signal indicate the forward movement direction. If condition G is satisfied in S531, the controller 5 sets the second driving state information as the forward movement state in S532.

If condition G is not satisfied, the controller 5 identifies whether condition H of FIG. 7 is satisfied. Condition H corresponds to the case in which the movement state information is the stopped state or at least one of the first wheel direction signal or the second wheel direction signal indicates the reverse movement direction. If condition H is satisfied in S533, the controller 5 sets the second driving state information as the reverse movement state in S534. If condition H is not satisfied, the controller 5 maintains the second driving state information to be the stopped state which is the previous driving state information in S540.

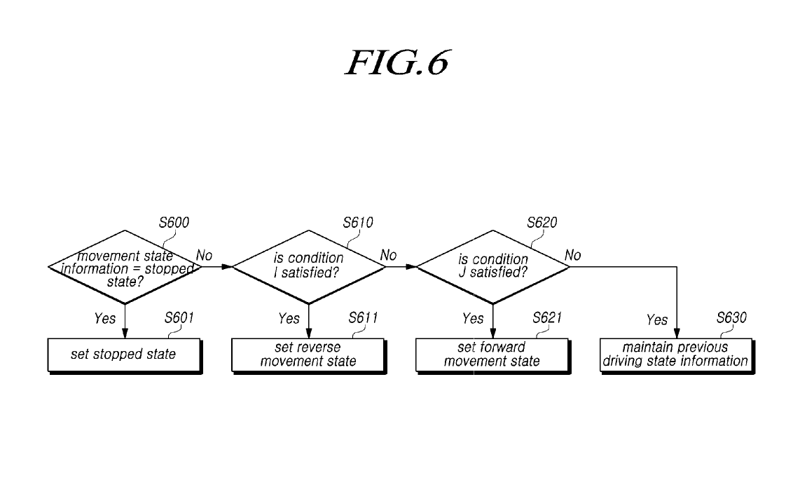

Referring to FIG. 6, the controller 5 according to the present embodiments identifies the movement state information if the gear signal of the vehicle corresponds to a gear (for example, a neutral gear or a park gear) other than the drive gear and the reverse gear. If the movement state information is the stopped state in S600, the controller 5 sets the second driving state information as the stopped state in S601.

If the movement state information is not the stopped state, that is, if the movement state information is the moving state, the controller 5 identifies whether condition I of FIG. 7 is satisfied. Condition I corresponds to the case in which both the first wheel direction signal and the second wheel direction signal indicate the reverse movement direction. If condition I is satisfied in S610, the controller 5 sets the second driving state information as the reverse movement state in S611.

If condition I is not satisfied, the controller 5 identifies whether condition J of FIG. 7 is satisfied. Condition J corresponds to the case in which both the first wheel direction signal and the second wheel direction signal indicate the forward movement direction. If condition J is satisfied in S620, the controller 5 sets the second driving state information as the forward movement state in S621. Otherwise, the controller 5 maintains the second driving state information to be the previous driving state information in S630.

As described above, if the gear signal is received, the controller 5 according to the present embodiments may output the second driving state information based on the first driving state information, the movement state information, the first wheel direction signal, and the second wheel direction signal at the time point at which the gear signal is received, so as to accurately determine the actual driving state of the vehicle and perform the vehicle control based on the accurate driving state.

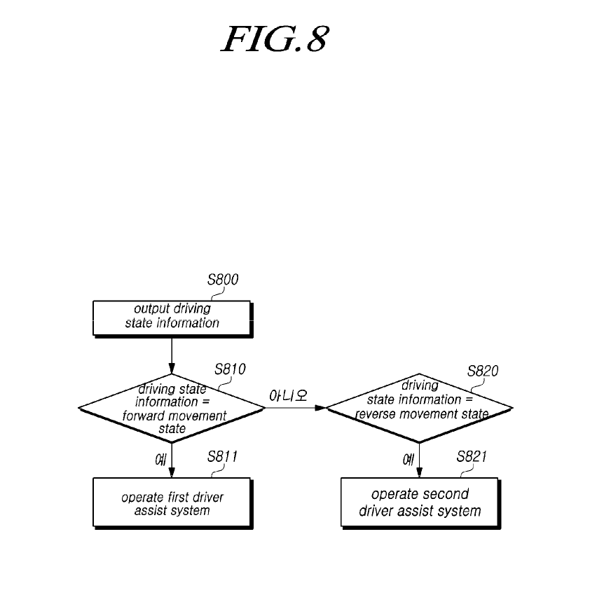

FIG. 8 illustrates an example of a process in which the controller 5 according to the present embodiments controls the vehicle based on the second driving state information output through the driving state determination process.

Referring to FIG. 8, the controller 5 according to the present embodiments outputs driving state information determined based on a gear signal, previous driving state information, movement state information, a first wheel direction signal, and a second wheel direction signal in S800.

If the output driving state information is the forward movement state in S810, the controller 5 performs control to operate a first driver assist system in S811.

The first driver assist system may be an AEB system for performing an alert or control for preventing the collision between the vehicle band the object ahead. Alternatively, the controller 5 may prevent the collision with the object ahead of the vehicle by directly controlling the alert device 30 or the brake device 40 of the vehicle.

If the output driving state information is the reverse movement state in S820, the controller 5 performs a control to operate a second driver assist system in S821.

The second driver assist system may be an RCTA system for performing an alert or control for preventing the collision between the vehicle and the object behind or alongside of the vehicle. Alternatively, the controller 5 may prevent the collision with the object behind the vehicle by directly controlling the alert device 30 or the brake device 40 of the vehicle.

Accordingly, the controller 5 according to the present embodiments may perform a collision prevention control of the vehicle based on the accurate driving direction of the vehicle, so as to prevent an unnecessary alert or control due to the object detected in a direction opposite the driving direction of the vehicle and perform an accurate control for the collision risk detected in the actual driving direction of the vehicle.

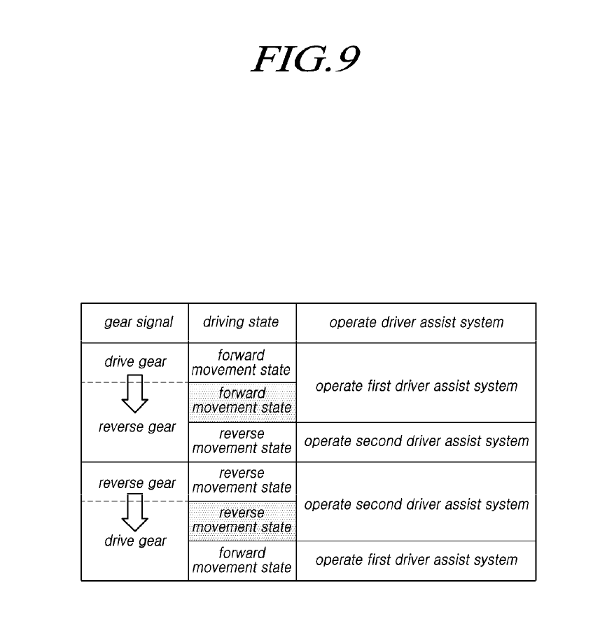

FIG. 9 illustrates an example of a method by which the controller 5 according to the present embodiments operates driver assist systems based on the driving state. The first driver assist system is a system for performing a forward collision avoidance control and the second driver assist system is a system for performing a backward collision avoidance control.

Referring to FIG. 9, if the gear signal is changed from the drive gear to the reverse gear, the controller 5 performs a control to operate the first driver assist system in a time interval in which the driving state is the forward movement state. In a time interval in which the driving state is the reverse movement state, the controller 5 performs a control to operate the second driver assist system.

That is, although the gear signal of the vehicle is changed to the reverse gear, the time interval in which the driving state of the vehicle is the forward movement state may exist. At this time, if the driver assist system operates based on the gear signal, the second driver assist system operates and thus the forward collision avoidance control cannot be performed. Accordingly, an unnecessary alert or control may be generated.

However, since the controller 5 according to the present embodiments operates the driver assist systems based on the driving state, the first driver assist system may operate in the time interval in which the gear signal is the reverse gear and the driving state is the forward movement state, and thus the collision avoidance control that matches the actual driving direction can be performed.

Further, if the gear signal is changed from the reverse gear to the drive gear, the controller 5 performs a control to operate the second driver assist system in the time interval in which the driving state is the reverse movement state. In the time interval in which the driving state is the forward movement state, the alert and control system 100 performs a control to operate the first driver assist system.

Accordingly, by operating the second driver assist system in the time interval in which the gear signal of the vehicle is the drive gear and the driving state is the reverse movement state, it is possible to prevent the unnecessary alert or control due to detection of an object ahead and control the vehicle according to the collision risk with an object behind the vehicle.

The present embodiments can accurately determine the actual driving state of the vehicle by determining the driving state of the vehicle based on the gear signal of the vehicle, the previous driving state information, the movement state information, the first wheel direction signal, and the second wheel direction signal.

Further, the present embodiments can improve the performance of the collision avoidance control of the vehicle while not generating the unnecessary alert or control by performing the collision avoidance control which may be generated in a driving direction of the vehicle based on the determined actual driving state of the vehicle.

The above embodiments of the present disclosure have been described only for illustrative purposes, and those skilled in the art will appreciate that various modifications and changes may be made thereto without departing from the scope and spirit of the disclosure. Therefore, exemplary embodiments of the present disclosure have been described for the sake of brevity and clarity. The scope of the present disclosure shall be construed based on the accompanying claims in such a manner that all of the technical ideas included within the scope equivalent to the claims belong to the present disclosure.

1. An alert and control system for assisting a driver, the alert and control system comprising:
an intra-vehicle sensor module configured to sense intra-vehicle information; and
a controller communicatively connected to the intra-vehicle sensor module and configured to:
receives at least one of a vehicle speed signal or a wheel pulse signal sensed by the intra-vehicle sensor module,
outputs movement state information, based on at least one of the vehicle speed signal or the wheel pulse signal,
receives a gear signal, a first wheel direction signal, and a second wheel direction signal sensed by the intra-vehicle sensor module,
outputs second driving state information, based on first driving state information when the gear signal is received, the gear signal, the first wheel direction signal, the second wheel direction signal, and the movement state information, and
controls an operation of at least one of an alert device or a brake device, based on the second driving state information.

2. The alert and control system of claim 1, wherein, the controller comprises:
a movement state determination module configured to output the movement state information, based on at least one of the vehicle speed signal or the wheel pulse signal;
a driving state determination module configured to receive the gear signal, the first wheel direction signal, and the second wheel direction signal and output the second driving state information, based on the first driving state information when the gear signal is received, the gear signal, the first wheel direction signal, the second wheel direction signal, and the movement state information; and
a collision prevention control module configured to control the operation of at least one of the alert device or the brake device, based on the second driving state information.

3. The alert and control system of claim 1, wherein, if both a driving direction indicated by the gear signal and a driving direction indicated by the first driving state information are a first direction,
the controller outputs a driving state indicating the second direction as the second driving state information if the movement state information is a moving state and both directions indicated by the first wheel direction signal and the second wheel direction signal are a second direction.

4. The alert and control system of claim 1, wherein, if a driving direction indicated by the gear signal is a first direction and a driving direction indicated by the first driving state information is a second direction,
the controller outputs a driving state indicating the first direction as the second driving state information if the movement state information is a stopped state, or the movement state information is a moving state and at least one of directions indicated by the first wheel direction signal and the second wheel direction signal is a first direction.

5. The alert and control system of claim 1, wherein, if the gear signal is a drive gear and the first driving state information is a forward movement state,
the controller outputs a reverse movement state as the second driving state information if the movement state information is a moving state and both directions indicated by the first wheel direction signal and the second wheel direction signal are a reverse movement direction.

6. The alert and control system of claim 1, wherein, if the gear signal is a drive gear and the first driving state information is a reverse movement state,
the controller outputs a forward movement state as the second driving state information if the movement state information is a stopped state, or the movement state information is a moving state and at least one of directions indicated by the first wheel direction signal and the second wheel direction signal is a forward movement direction.

7. The alert and control system of claim 1, wherein, if the gear signal is a drive gear and the first driving state information is a stopped state,
the controller outputs a reverse movement state as the second driving state information if both directions indicated by the first wheel direction signal and the second wheel direction signal are a reverse movement direction, and
the controller outputs a forward movement state as the second driving state information if the movement sate information is a stopped state or at least one of directions indicated by the first wheel direction signal and the second wheel direction signal is a forward movement direction.

8. The alert and control system of claim 1, wherein, if the gear signal is a reverse gear and the first driving state information is a reverse movement state,
the controller outputs a forward movement state as the second driving state information if the movement state information is a moving state and both directions indicated by the first wheel direction signal and the second wheel direction signal are a forward movement direction.

9. The alert and control system of claim 1, wherein, if the gear signal is a reverse gear and the first driving state information is a forward movement state,
the controller outputs a reverse movement state as the second driving state information if the movement state information is a stopped state, or the movement state information is a moving state and at least one of directions indicated by the first wheel direction signal and the second wheel direction signal is a reverse movement direction.

10. The alert and control system of claim 1 wherein, if the gear signal is a reverse gear and the first driving state information is a stopped state,
the controller outputs a forward movement state as the second driving state information if both directions indicated by the first wheel direction signal and the second wheel direction signal are a forward movement direction, and
the controller outputs a reverse movement state as the second driving state information if the movement state information is a stopped state or at least one of directions indicated by the first wheel direction signal and the second wheel direction signal is a reverse movement direction.

11. The alert and control system of claim 1, wherein, if the gear signal is a gear other than a drive gear and a reverse gear and the movement sate information is a moving state,
the controller outputs a reverse movement state as the second driving state information if both directions indicated by the first wheel direction signal and the second wheel direction signal are a reverse movement direction, and
the controller outputs a forward movement state as the second driving state information if both directions indicated by the first wheel direction signal and the second wheel direction signal are a forward movement direction.

12. The alert and control system of claim 1, wherein the controller controls the operation of at least one of the alert device or the brake device in order to prevent a collision with an object ahead if the second driving state information is a forward movement state, and
controls an operation of at least one of the alert device and the brake device in order to prevent a collision with an object behind the vehicle if the second driving state information is a backward movement state.

13. An alert and control method of assisting a driver, the alert and control method comprising:
receiving at least one of a vehicle speed signal or a wheel pulse signal sensed by an intra-vehicle sensor module;
outputting movement state information, based on at least one of a vehicle speed signal or a wheel pulse signal;
receiving a gear signal, a first wheel direction signal, and a second wheel direction signal sensed by the intra-vehicle sensor module;
outputting second driving state information, based on first driving state information when the gear signal is received, the gear signal, the first wheel direction signal, the second wheel direction signal, and the movement state information; and
controlling an operation of at least one of an alert device or a brake device, based on the second driving state information.

14. The alert and control method of claim 13, wherein, if both a driving direction indicated by the gear signal and a driving direction indicated by the first driving state information are a first direction,
the outputting of the second driving state information comprises outputting a driving state indicating the second direction as the second driving state information if the movement state information is a moving state and both directions indicated by the first wheel direction signal and the second wheel direction signal are a second direction.

15. The alert and control method of claim 13, wherein, if driving direction indicated by the gear signal is a first direction and a driving direction indicated by the first driving state information is a second direction,
the outputting of the second driving state information comprises outputting a driving state indicating the first direction as the second driving state information if the movement state information is a stopped state, or the movement state information is a moving state and at least one of directions indicated by the first wheel direction signal and the second wheel direction signal is a first direction.

16. The alert and control method of claim 13, wherein the controlling of the operation of at least one of the alert device and the brake device, based on the second driving state information comprises:
controlling an operation of at least one of the alert device and the brake device by a first driver assist system if the second driving state information is a forward movement state, and
controlling an operation of at least one of the alert device and the brake device by a second driver assist system if the second driving state information is a backward movement state.
